(19) United States
(12) Patent Application Publication
(10) Pub. No.: US 2026/0200520 A1
(43) Pub. Date: Jul. 16, 2026

(54) ELECTRIC POWER STEERING DEVICE

(71) Applicant: KYB Corporation, Tokyo (JP)

(72) Inventors: Masashi AOYAMA, Gifu (JP); Souichirou MIYAKE, Aichi (JP); Hideki TANAKA, Gifu (JP)

(73) Assignee: KYB Corporation, Tokyo (JP)

(21) Appl. No.: 19/135,626

(22) PCT Filed: Nov. 15, 2023
(86) PCT No.: PCT/JP2023/041041

§ 371 Date: Jun. 4, 2025

(30) Foreign Application Priority Data
Dec. 5, 2022 (JP) 2022-194402

(51) Int. Cl. B62D 5/04; G01L 3/10; G01L 5/22

(52) U.S. Cl. CPC B62D 5/0463; B62D 5/0481; G01L 3/105; G01L 5/221

(57) ABSTRACT

An electric power steering device includes the input shaft to which a steering torque is input, an output shaft that is coupled to the input shaft via a torsion bar, a torque sensor that detects a steering torque, a connector that is held by a case of the torque sensor and is electrically connected to the torque sensor, a through hole that is formed to penetrate an outer wall of a housing, and a cable that is inserted into the through hole and electrically connects an external device and the connector. The cable has a relief portion that extends linearly from the through hole along the inner surface of the housing.

### TECHNICAL FIELD

The present invention relates to an electric power steering device.

### BACKGROUND ART

JP2017-61209A discloses an electric power steering device including an input shaft, an output shaft, a torque sensor, a housing, a cable electrically connecting the torque sensor and a controller for controlling driving of an electric motor, and a connector held by a case of the torque sensor and connected to the cable.

### SUMMARY OF INVENTION

In the electric power steering device described in JP2017-61209A, the cable electrically connected to the controller is bent along an inner wall surface of the housing in the housing, and further bent to be folded back in the vicinity of the connector.

Thus, when the cable is bent and connected to the connector, a load is applied by a restoring force of the cable to the connector or the case of the torque sensor that holds the connector, which may cause a bad influence.

The present invention has been made in view of the above problems, and an object thereof is to reduce a load applied to a connector or a case of a torque sensor holding the connector in an electric power steering device.

According to one aspect of the present invention, an electric power steering device includes: an input shaft to which a steering torque is input; an output shaft coupled to the input shaft via a torsion bar; a torque sensor attached across the input shaft and the output shaft to detect the steering torque; a housing configured to house the input shaft, the output shaft, and the torque sensor; an electric motor configured to generate a steering assist torque based on a detection result of the torque sensor; a connector held in a case of the torque sensor and electrically connected to the torque sensor; a through hole formed to penetrate an outer wall of the housing; and a cable inserted into the through hole and electrically connecting an external device and the connector. The cable has a relief portion linearly extending from the through hole along an inner surface of the housing.

### BRIEF DESCRIPTION OF DRAWINGS

FIG. 1 is a configuration diagram of an electric power steering device according to an embodiment of the present invention.

FIG. 2 is an external view of the vicinity of an assist mechanism in the electric power steering device according to the embodiment of the present invention.

FIG. 3 is a cross-sectional view of the vicinity of the assist mechanism in the electric power steering device according to the embodiment of the present invention.

FIG. 4 is a plan view of the vicinity of the assist mechanism in the electric power steering device according to the embodiment of the present invention, in which a first housing is not shown.

FIG. 5 is an enlarged partial cross-sectional view of the vicinity of a torque sensor of the assist mechanism in the electric power steering device according to the embodiment of the present invention.

FIG. 6 is a view showing a comparative example of the assist mechanism in the electric power steering device according to the embodiment of the present invention.

### DESCRIPTION OF EMBODIMENTS

Hereinafter, an electric power steering device 100 according to an embodiment of the present invention will be described with reference to the drawings.

The electric power steering device 100 is mounted on a vehicle and assists the steering of a steering wheel 1 by a driver.

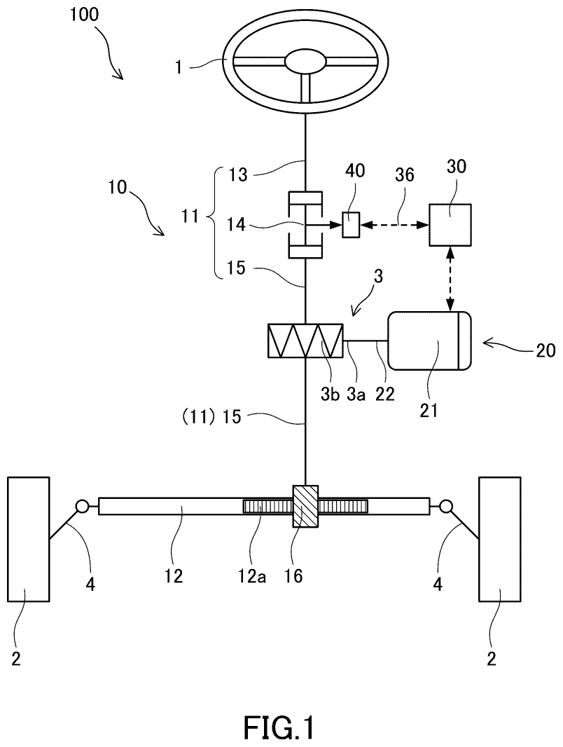

In the present embodiment, as shown in FIG. 1, a single pinion type electric power steering device 100 in which a steering torque by a driver and a steering assist torque by an electric motor 21 are input to a rack shaft 12 will be described.

First, an overall configuration of the electric power steering device 100 will be described with reference to FIG. 1.

The electric power steering device 100 includes a steering mechanism 10 that turn wheels 2 according to rotation of the steering wheel 1 by steering by the driver, an assist mechanism 20 that assists the steering by the driver, a torque sensor 40 that detects a steering torque input by the driver through the steering wheel 1, and a controller 30 that controls driving of the electric motor 21 based on a detection result of the torque sensor 40.

The steering mechanism 10 includes a steering shaft 11 that rotates according to the rotation of the steering wheel 1, and a rack shaft 12 that turns the wheels 2 according to the rotation of the steering shaft 11.

The steering shaft 11 includes an input shaft 13 that rotates in accordance with the steering of the steering wheel 1 by the driver, an output shaft 15 that is linked to the rack shaft 12 steering the wheels 2, and a torsion bar 14 that couples the input shaft 13 and the output shaft 15.

A pinion 16 that meshes with a rack 12a formed in the rack shaft 12 is formed in a lower portion of the output shaft 15. When the steering wheel 1 is steered, the steering shaft 11 rotates, the rotation of the steering shaft 11 is converted into linear motion of the rack shaft 12 by the pinion 16 and the rack 12a, and the wheels 2 are turned through knuckle arms 4. Instead of a configuration in which the pinion 16 is formed on the lower portion of the output shaft 15, a configuration in which a pinion shaft meshing with the rack shaft 12 and the output shaft 15 are connected via an intermediate shaft may be adopted.

The assist mechanism 20 includes the electric motor 21, which is a power source of the steering assist torque, an output shaft 22 to which a driving force of the electric motor 21 is transmitted, and a speed reduction mechanism 3 that reduces rotation of the electric motor 21 and transmits the rotation to the output shaft 15. The speed reduction mechanism 3 includes a worm shaft 3a that is connected to the output shaft 22 of the electric motor 21, and a worm wheel 3b that meshes with the worm shaft 3a and is fixed to the output shaft 15.

The output of the electric motor 21 is decelerated by the speed reduction mechanism 3 and then transmitted to the rack shaft 12 through the output shaft 15 as a steering assist torque.

The torque sensor 40 detects a steering torque applied to the torsion bar 14 based on a rotation angle difference between the input shaft 13 and the output shaft 15.

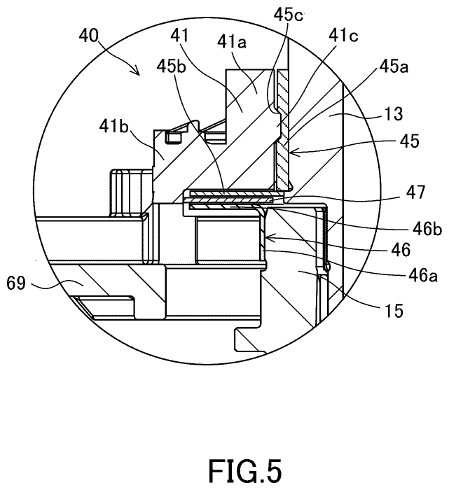

A substrate 47 (see FIG. 5) of the torque sensor 40 and the controller 30 are electrically connected via a cable 36 as a signal line. Power is supplied from the controller 30 to the torque sensor 40 through the cable 36, and a steering torque signal detected by the torque sensor 40 is output to the controller 30.

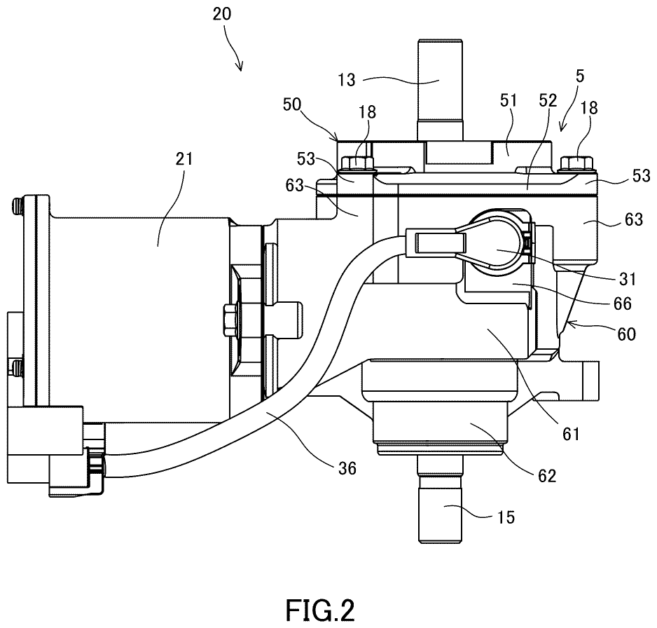

Next, the structure of the assist mechanism 20 in the electric power steering device 100 will be described in detail with reference to FIGS. 2 to 5.

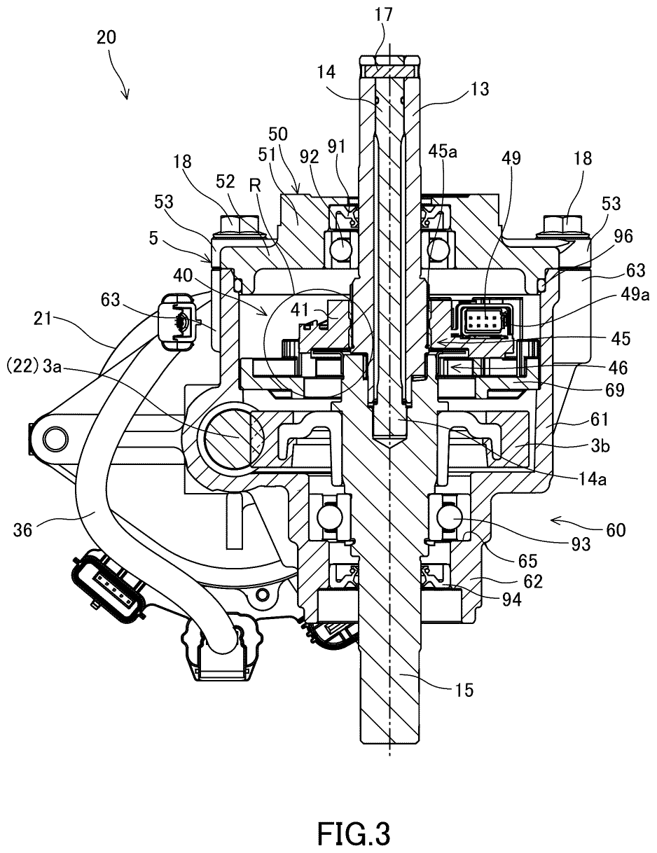

As shown in FIGS. 2 and 3, the assist mechanism 20 includes the electric motor 21, a housing 5, the input shaft 13, the torsion bar 14, the output shaft 15, and the torque sensor 40. The input shaft 13, the output shaft 15, and the torque sensor 40 are accommodated in the housing 5.

As shown in FIGS. 2 and 3, the housing 5 includes a first housing 50 and a second housing 60.

As shown in FIGS. 2 and 3, the first housing 50 includes a cylindrical portion 51, a flange portion 52 extending radially outward from an outer periphery of the cylindrical portion 51 and covering an opening of the second housing 60, and attachment portions 53 into which bolts 18 for fastening the first housing 50 and the second housing 60 are inserted.

As shown in FIG. 3, a sealing member 91 that is in sliding contact with an outer peripheral surface of the input shaft 13 and a bearing 92 that rotatably supports the input shaft 13 are provided inside the cylindrical portion 51. The sealing member 91 prevents foreign matter from entering the first housing 50.

As shown in FIGS. 2 and 3, each of the attachment portions 53 is formed to protrude radially outward from an outer peripheral surface of the flange portion 52. In the present embodiment, three attachment portions 53 are provided at intervals in a circumferential direction.

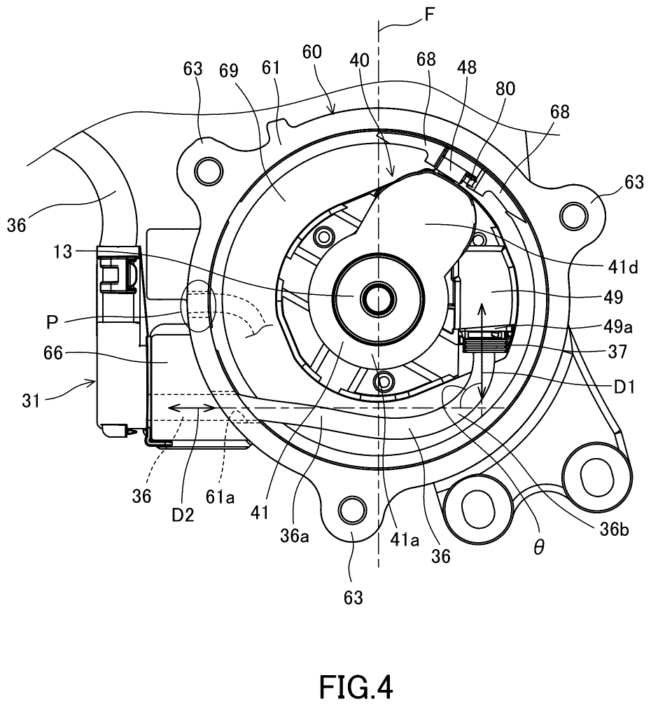

As shown in FIGS. 2 to 4, the second housing 60 includes a first cylindrical portion 61, a second cylindrical portion 62 having an inner diameter smaller than that of the first cylindrical portion 61, attachment portions 63 into which the bolts 18 for fastening the first housing 50 and the second housing 60 are inserted, a holder attachment portion 66 (see FIG. 4) to which a cable holder 31 for holding the cable 36 is attached, and a plate 69 provided inside the first cylindrical portion 61.

As shown in FIG. 2, the electric motor 21 is attached to an outer wall surface of the first cylindrical portion 61. As shown in FIG. 3, the torque sensor 40 and the worm wheel 3b are accommodated inside the first cylindrical portion 61. The worm shaft 3a coupled to the output shaft 22 of the electric motor 21 is disposed to penetrate the first cylindrical portion 61, and meshes with the worm wheel 3b accommodated in the first cylindrical portion 61. As shown in FIG. 3, the inside of the first cylindrical portion 61 is partitioned by the disk-shaped plate 69 into a space in which the torque sensor 40 is provided and a space in which the worm wheel 3b is provided.

As shown in FIG. 4, the first cylindrical portion 61 has a through hole 61a formed to penetrate the first cylindrical portion 61. The cable 36 is inserted into the through hole 61a.

As shown in FIG. 3, a bearing 93 that rotatably supports the output shaft 15 and a sealing member 94 that is in sliding contact with an outer peripheral surface of the output shaft 15 are provided inside the second cylindrical portion 62. The sealing member 94 prevents foreign matter from entering the second housing 60.

As shown in FIGS. 2 and 3, the first housing 50 and the second housing 60 are fastened by bolts 18. An annular O-ring 96 is provided between the first housing 50 and the second housing 60.

As shown in FIG. 3, a hollow portion that opens to a lower end surface is formed in an axial center of the input shaft 13, and the torsion bar 14 is accommodated in the hollow portion. An upper portion of the torsion bar 14 is coupled to the input shaft 13 by a pin 17. A lower end of the torsion bar 14 protrudes from a lower end opening portion of the hollow portion of the input shaft 13 and is coupled to the output shaft 15 via a serration 14a. The torsion bar 14 transmits the steering torque input to the input shaft 13 via the steering wheel 1 to the output shaft 15, and is twisted and deformed about the axial center according to the steering torque. As described above, the input shaft 13 and the output shaft 15 rotate relative to each other in accordance with an amount of torsion of the torsion bar 14, and the torque sensor 40 detects a steering torque based on the rotation angle difference between the input shaft 13 and the output shaft 15 due to the relative rotation.

Next, a specific structure of the torque sensor 40 will be described with reference to FIGS. 3 to 5. FIG. 5 is an enlarged view of a region R surrounded by a circle in FIG. 3.

As shown in FIGS. 3 and 5, the torque sensor 40 includes a case 41, a first sensor rotor 45 as a rotor portion that rotates integrally with the input shaft 13, a second sensor rotor 46 that rotates integrally with the output shaft 15, the substrate 47 that detects the steering torque and outputs a signal to the controller 30, and a connector 49 to which the cable 36 (see FIGS. 3 and 4) is connected.

As shown in FIG. 4 and the like, the case 41 has a substantially annular shape through which the input shaft 13 is inserted, and is provided to be rotatable relative to the input shaft 13.

The case 41 is formed of a resin material. As shown in FIGS. 4 and 5, the case 41 includes a first cylindrical portion 41a having a cylindrical shape, a second cylindrical portion 41b having a larger diameter than the first cylindrical portion 41a and having a cylindrical shape, an annular protrusion 41c protruding radially inward from an inner peripheral surface of the first cylindrical portion 41a, a bulge portion 41d formed to bulge radially outward from an outer peripheral surface of the first cylindrical portion 41a, and an engagement portion 48 formed to further protrude from an outer surface of the bulge portion 41d in a radial direction. In the present embodiment, the protrusion 41c is formed to be tapered radially inward.

As shown in FIG. 4, the engagement portion 48 engages with locking portions 68 formed in the plate 69. A pair of locking portions 68 are provided at intervals in a rotation direction of the input shaft 13 so as to extend in the axial direction from an end surface of the plate 69. A plate spring 80 is provided between one end surface of the engagement portion 48 in the rotation direction and the locking portions 68. Since the engagement portion 48 is pressed against the one locking portion 68 by an elastic force of the plate spring 80, the relative rotation of the torque sensor 40 (case 41) relative to the housing 5 is restricted.

As shown in FIG. 5, the first sensor rotor 45 includes a first rotor member 45a press-fitted to the outer peripheral surface of the input shaft 13, and a plurality of plate portions 45b attached to a lower end surface of the first rotor member 45a to face the substrate 47 and formed to extend radially in the radial direction. The first rotor member 45a is formed of a resin material. The plurality of plate portions 45b are arranged at predetermined intervals in the rotation direction. The first rotor member 45a and the plurality of plate portions 45b are integrated with each other by insert molding to form the first sensor rotor 45.

As shown in FIG. 5, an annular engagement groove 45c with which the protrusion 41c of the case 41 is engaged is provided on an outer peripheral surface of the first rotor member 45a. The engagement groove 45c is formed in such a shape that a side surface thereof comes into surface contact with a side surface of the protrusion 41c, specifically, the side surface of the engagement groove 45c is formed such that a width becomes narrower toward a bottom surface.

In the torque sensor 40 according to the present embodiment, due to the engagement of the protrusion 41c with the engagement groove 45c, the case 41 is relatively rotatably supported by the input shaft 13 via the first rotor member 45a in a so-called floating state. Accordingly, as the input shaft 13 rotates, the plate portions 45b of the first sensor rotor 45 rotate relative to the substrate 47. The engagement of the protrusion 41c formed in the above-described shape with the engagement groove 45c restricts the movement of the case 41 in the axial direction and the radial direction of the input shaft 13.

As shown in FIG. 5, the second sensor rotor 46 includes a press-fit portion 46a press-fitted to the outer peripheral surface of the output shaft 15, and a plurality of plate portions 46b radially extending from an outer peripheral surface of the press-fit portion 46a and arranged to face the substrate 47 at predetermined intervals in the rotation direction.

The substrate 47 is fixed in the case 41, and is disposed between the plate portions 45b of the first sensor rotor 45 and the plate portions 46b of the second sensor rotor 46. A detection coil pattern is formed on the substrate 47 by patterning. The detection coil pattern detects a steering torque by detecting a rotation angle difference between the input shaft 13 and the output shaft 15, that is, a change in magnetic field caused by the rotation angle difference between the first sensor rotor 45 and the second sensor rotor 46. As described above, the torque sensor 40 is an induction-type sensor that detects a steering torque based on an inductance change detected by the detection coil pattern.

As shown in FIGS. 3 and 4, the connector 49 is disposed on an upper surface of the case 41 and is held by the case 41. The connector 49 is a female connector having an attachment opening 49a. A male connector 37 (see FIG. 4) provided at a distal end of the cable 36 is inserted into the attachment opening 49a.

One end of the cable 36 is connected to the connector 37 (torque sensor 40). The cable 36 is pulled out of the housing 5 through the through hole 61a, the holder attachment portion 66, and the cable holder 31 formed in the first cylindrical portion 61. The other end of the cable 36 is connected to the controller 30. It is not necessary to connect the torque sensor 40 and the controller 30 with one cable 36. For example, a relay connector may be provided in the cable holder 31 or the through hole 61a, and the cable 36 in the housing 5 and the cable 36 outside the housing 5 may be connected by the relay connector.

When the cable 36 is guided from the outside to the inside of the housing 5, a through hole extending in the radial direction toward a center of the housing 5 (a rotation axis of the input shaft 13) may be provided in the housing 5, and the cable 36 may be inserted into the through hole (a region indicated by P in FIG. 4). However, in such a configuration, when the cable 36 is inserted into the through hole, the cable 36 is guided into the housing 5 to face the input shaft 13 and the case 41. Therefore, in the housing 5, the cable 36 is bent to bypass the input shaft 13 and the case 41 (see dotted lines in FIG. 4). Thus, when the cable 36 is bent and connected to the connector 49, a load is applied by a restoring force of the cable 36 to the connector 49 or the case 41 of the torque sensor 40 that holds the connector 49, which may cause a bad influence. Specifically, when a load is applied to the connector 49, the case 41 that holds the connector 49 may rotate while being pressed against the first rotor member 45a. When the first rotor member 45a rotates in a state where the case 41 is pressed against the first rotor member 45a, a contact portion between the engagement groove 45c of the first rotor member 45a and the protrusion 41c of the case 41 is worn. As a result, rattling occurs in the substrate 47 held in the case 41, and the detection accuracy of the torque sensor 40 may be deteriorated.

Thus, as shown in FIG. 4, in the electric power steering device 100 according to the present embodiment, the through hole 61a is provided at a position that is parallel and off-set from a position P at which an axial center faces a center of the housing 5 (the rotation axis of the input shaft 13). In other words, the through hole 61a is provided on a plane orthogonal to the rotation axis of the input shaft 13 such that the axial center is inclined with respect to a direction toward the center of the housing 5 (the rotation axis of the input shaft 13), that is, an opening of the through hole 61a does not face the case 41 of the torque sensor 40 or the input shaft 13.

Thus, by providing the through hole 61a, it is not necessary to bend the cable 36 inserted into the through hole 61a in order to bypass the case 41 of the torque sensor 40 and the input shaft 13. In other words, the cable 36 inserted into the through hole 61a can be linearly guided along an inner surface of the housing 5 (hereinafter, a portion linearly extending along the inner surface of the housing 5 in the cable 36 will be referred to as a “relief portion 36a”).

In the cable 36, a portion connecting the connector 49 and the relief portion 36a is bent (hereinafter, a portion connecting the connector 49 and the relief portion 36a in the cable 36 is referred to as a “bent portion 36b”). In the bent portion 36b, a restoring force for returning the cable 36 to a linear state acts. On the other hand, in the relief portion 36a, the restoring force does not occur, and conversely, the relief portion 36a can absorb a load caused by the restoring force of the cable 36 generated at the other part (the bent portion 36b or the like) of the cable 36. Accordingly, by providing the cable 36 with the relief portion 36a, the load due to the restoring force of the cable 36 acting on the connector 49 or the case 41 of the torque sensor 40 that holds the connector 49 can be reduced.

In the electric power steering device 100 according to the present embodiment, as shown in FIG. 4, the connector 49 is provided in a region on an opposite side of the through hole 61a across the input shaft 13, and specifically, in a region on an opposite side of the through hole 61a across a plane F orthogonal to the relief portion 36a (an axis D2 of the through hole 61a) among planes including the rotation axis of the input shaft 13. Thus, by providing the connector 49 in a region opposite to the through hole 61a across the input shaft 13, a length of the cable 36 in the housing 5 can be increased. Accordingly, even if the cable 36 is bent, a long length of the cable 36 allows the cable 36 to have play, so that the load due to the restoring force of the cable 36 can be reduced.

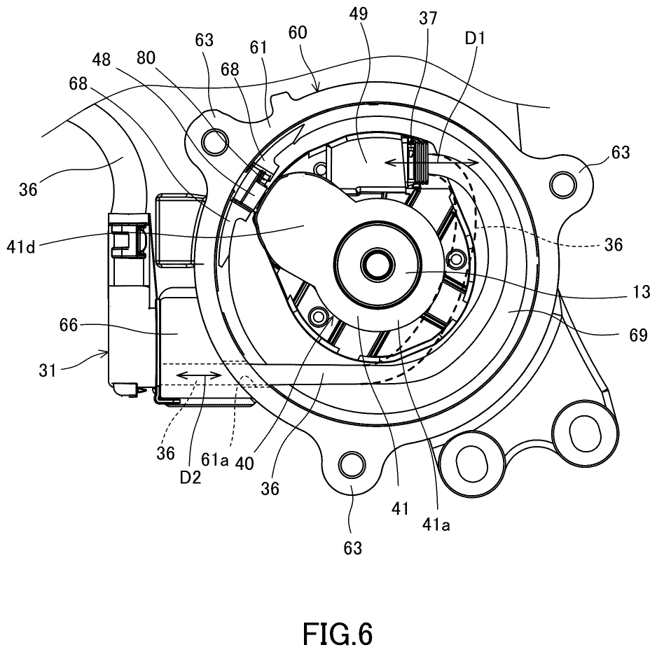

An angle θ between the axis D2 of the through hole 61a and a connecting direction D1 of the connector 49 and the cable 36 is preferably about 90°. For example, the angle θ between the axis D2 of the through hole 61a and the connecting direction D1 of the connector 49 and the cable 36 is 90 degrees or less (see FIG. 6). In FIG. 6, at the angle θ of substantially 0°, when the elasticity of the cable 36 is lost due to aging deterioration or the like, the cable 36 may be linearly deformed so that a portion between the connector 49 and the through hole 61a connects the connector 49 and the through hole 61a in the shortest distance (see thick dotted lines in FIG. 6). Thus, when the cable 36 is deformed linearly, the cable 36 may come into contact with the case 41 of the torque sensor 40 or the input shaft 13, which may cause a bad influence. On the other hand, when the angle θ is 90° or more, the length of the cable 36 is shortened, and the play is reduced accordingly. Therefore, by setting the angle θ to be substantially 90°, even when the cable 36 is deformed linearly, the cable 36 can be prevented from coming into contact with the case 41 of the torque sensor 40 and the input shaft 13, and the play of the cable 36 can be ensured at the maximum.

The connector 49 and the through hole 61a are preferably located on the same plane orthogonal to the rotation axis of the input shaft 13. Thus, by providing the connector 49 and the through hole 61a on the same plane, a bent portion of the cable 36 in a rotation axis direction of the input shaft 13 can be eliminated.

At an intermediate portion between the connector 49 and the through hole 61a, the cable 36 may be fixed to the housing 5 (the plate 69) by a fixing member (not shown). Thus, by fixing the cable 36 to the housing 5 (the plate 69), the load acting on the connector 49 or the case 41 of the torque sensor 40 that holds the connector 49 can be reduced. In particular, the bent portion 36b is preferably fixed to the housing 5 by the fixing member. By fixing the bent portion 36b, the restoring force for returning the bent portion 36b to a linear state can be reduced by the fixing member, and the load acting on the connector 49 or the case 41 of the torque sensor 40 that holds the connector 49 can be further reduced.

Hereinafter, the configuration, operation, and effect of the embodiment of the present invention will be collectively described.

The electric power steering device 100 includes the input shaft 13 to which a steering torque is input, the output shaft 15 that is coupled to the input shaft 13 via the torsion bar 14, the torque sensor 40 that is attached across the input shaft 13 and the output shaft 15 to detect a steering torque, the housing 5 that houses the input shaft 13, the output shaft 15, and the torque sensor 40, the electric motor 21 that generates a steering assist torque based on a detection result of the torque sensor 40, the connector 49 that is held by the case 41 of the torque sensor 40 and is electrically connected to the torque sensor 40, the through hole 61a that is formed to penetrate an outer wall of the housing 5, and the cable 36 that is inserted into the through hole 61a and electrically connects an external device and the connector 49. The cable 36 has the relief portion 36a that extends linearly from the through hole 61a along the inner surface of the housing 5.

In this configuration, the cable 36 has the relief portion 36a that linearly extends from the through hole 61a along the inner surface of the housing 5. Accordingly, since it is not necessary to bend the cable 36 in order to avoid the input shaft 13, a bending amount of the cable 36 can be reduced. Accordingly, the load due to the restoring force of the cable 36 acting on the connector 49 or the case 41 of the torque sensor 40 that holds the connector 49 can be reduced.

In the electric power steering device 100, the connector 49 is provided in a region on an opposite side of the through hole 61a across the input shaft 13, and the angle θ between the axis D2 of the through hole 61a and the connecting direction D1 of the connector 49 and the cable 36 is approximately 90°.

In this configuration, since the connector 49 is provided in a region opposite to the through hole 61a across the input shaft 13, the length of the cable 36 in the housing 5 can be increased. Accordingly, even if the cable 36 is bent, a long length of the cable 36 allows the cable 36 to have play, so that the load due to the restoring force of the cable 36 can be reduced. Further, since the angle θ between the axis D2 of the through hole 61a and the connecting direction D1 of the connector 49 and the cable 36 is substantially 90°, the bending amount of the cable 36 can be minimized, and a length of the relief portion 36a can be maximized. For example, when the angle θ between the axis D2 of the through hole 61a and the connecting direction D1 of the connector 49 and the cable 36 is set to 90 degrees or more (see FIG. 6), if the elasticity of the cable 36 is lost due to aging deterioration or the like, the cable 36 may be linearly deformed so that the portion between the connector 49 and the through hole 61a connects the connector 49 and the through hole 61a in the shortest distance (see thick dotted lines in FIG. 6). Thus, when the cable 36 is deformed linearly, the cable 36 may come into contact with the case 41 of the torque sensor 40 or the input shaft 13, which may cause a bad influence. Therefore, by setting the angle θ to be substantially 90°, even when the cable 36 is deformed linearly, the cable 36 can be prevented from coming into contact with the case 41 of the torque sensor 40 and the input shaft 13. In addition, by increasing the maximum limit of the length of the relief portion 36a, it is possible to increase a region for relaxing the load due to the restoring force of the cable 36.

In the electric power steering device 100, the connector 49 and the through hole 61a are located on the same plane orthogonal to the rotation axis of the input shaft 13.

In this configuration, by providing the connector 49 and the through hole 61a on the same plane, the bent portion of the cable 36 in the rotation axis direction of the input shaft 13 can be eliminated.

The electric power steering device 100 further includes a fixing member that fixes the cable 36 to the housing 5, the cable 36 further has the bent portion 36b that connects the connector 49 and the relief portion 36a, and the fixing member fixes the bent portion 36b to the housing 5.

In this configuration, since the bent portion 36b of the cable 36 is fixed to the housing 5, the load acting on the connector 49 or the case 41 of the torque sensor 40 that holds the connector 49 can be reduced.

Although the embodiment of the present invention has been described above, the above embodiment is merely a part of the application of the present invention, and the technical scope of the present invention is not limited to the specific configuration of the above embodiment.

The torque sensor 40 may also have a function of an angle sensor that detects an absolute rotation angle of the steering shaft 11.

In the above embodiment, the single pinion type electric power steering device 100 in which the steering torque by the driver and the steering assist torque by the electric motor 21 are input to the rack shaft 12 via the common steering shaft 11 has been described as an example. However, the electric power steering device 100 may be a dual pinion electric power steering device in which the steering torque by the driver and the steering assist torque by the electric motor 21 are independently input to the rack shaft 12. The electric power steering device 100 is not limited to a rack and pinion type, and may be a column assist type.

In the above embodiment, a case where the torque sensor 40 is an inductance sensor has been described. However, the torque sensor 40 may be a magnetic sensor, and a torque detection method is not limited.

This application claims priority based on Japanese Patent Application No.2022-194402 filed with the Japan Patent Office on Dec. 5, 2022, the entire contents of which are incorporated into this specification.

1. An electric power steering device comprising:
an input shaft to which a steering torque is input;
an output shaft coupled to the input shaft via a torsion bar;
a torque sensor attached across the input shaft and the output shaft to detect the steering torque;
a housing configured to house the input shaft, the output shaft, and the torque sensor;
an electric motor configured to generate a steering assist torque based on a detection result of the torque sensor;
a connector held in a case of the torque sensor and electrically connected to the torque sensor;
a through hole formed to penetrate an outer wall of the housing; and
a cable inserted into the through hole and electrically connecting an external device and the connector, wherein
the cable has a relief portion linearly extending from the through hole along an inner surface of the housing.

2. The electric power steering device according to claim 1, wherein
the connector is provided in a region opposite to the through hole with the input shaft interposed therebetween, and
an angle formed between an axial direction of the through hole and a connecting direction of the connector and the cable is substantially 90°.

3. The electric power steering device according to claim 1, wherein
the connector and the through hole are located on the same plane orthogonal to a rotation axis of the input shaft.

4. The electric power steering device according to claim 1, further comprising:
a fixing member configured to fix the cable to the housing, wherein the cable further has a bent portion connecting the connector and the relief portion, and the fixing member fixes the bent portion to the housing.
